(19) United States
(12) Patent Application Publication
(10) Pub. No.: US 2025/0068456 A1
(43) Pub. Date: Feb. 27, 2025

(54) CONTAINER MIGRATION DEVICE, CONTAINER MIGRATION METHOD, AND COMPUTER READABLE MEDIUM

(71) Applicant: Mitsubishi Electric Corporation, Tokyo (JP)

(72) Inventors: Masahiro HIRAMORI, Tokyo (JP); Takehisa MIZUGUCHI, Tokyo (JP)

(73) Assignee: Mitsubishi Electric Corporation, Tokyo (JP)

(21) Appl. No.: 18/941,157

(22) Filed: Nov. 8, 2024

Related U.S. Application Data
(63) Continuation of application No. PCT/JP2022/025423, filed on Jun. 26, 2022.

(51) Int. Cl. G06F 9/455

(52) U.S. Cl. CPC G06F 9/45558; G06F 2009/4557

(57) ABSTRACT

A container migration device causes an operation mode of a migration source proxy (120) to transition from a transfer mode of: receiving data being transmitted from a request source container (110) that requests data processing; and transferring the received data to a migration source container (130) being a request destination container, to a queuing mode of saving the data instead of transferring. After the operation mode of the migration source proxy transitions to the queueing mode and the migration destination container (150) is activated, the container migration device causes the operation mode of the migration source proxy to transition to a queue sendout mode of sending out the saved data to a migration destination proxy. After sendout of the saved data is completed, the container migration device causes the request source container to change a data transmission destination from the migration source proxy to a migration destination proxy (140).

### CROSS REFERENCE TO RELATED APPLICATION

This application is a Continuation of PCT International Application No. PCT/JP2022/025423, filed on Jun. 26, 2022, which is hereby expressly incorporated by reference into the present application.

### TECHNICAL FIELD

The present disclosure relates to migration of a software container.

### BACKGROUND ART

In recent years, Open Source Software (OSS) is sometimes used for product development of embedded devices. In addition, there are embedded devices to which third-party applications can be added after the products are purchased.

If a non-significant application such as an OSS and an additional application behaves abnormally, it may occupy hardware resources and system resources, influencing operation of a significant application.

To prevent this problem, a means that performs software containerization of non-significant applications is available.

This means can reduce the influence of resource occupancy resulting from unusual operation of the non-significant applications, and enables stable operation of the significant application.

Generally, an application is often composed of a plurality of functions. Specific examples of the functions include a cloud communication function, an AI abnormality detection function, and a database function of the application. Note that AI stands for artificial intelligence.

When containerizing an application, each function is containerized rather than containerizing the whole application, so that influence of abnormal behavior can be reduced on a function-by-function basis.

When such an application is executed on a device, a plurality of containers are executed in the device, and functions are accessed between the containers. An example of such a mechanism is Representational State Transfer (REST).

Here, a need arises to migrate an operating container to another device due to reasons such as memory shortage of the device, device maintenance, and device upgrade.

To move the operating container, the container must be stopped once, and necessary data must be transferred.

Patent Literature 1 discloses a technique for shortening a downtime of a container by differential transfer of a container image.

However, even with this technique, the container downtime is not reduced to zero. Therefore, when a request and data are transmitted to a stopped container from another container, a transmission destination container cannot accept the request and data.

In addition, there is a demand for being able to continuously process collected

data within a container so as to, for example, collect sensor data without losing the collected data even while the container migrates.

### CITATION LIST

### Patent Literature

Patent Literature 1: JP 2019-530072 A

### SUMMARY OF INVENTION

### Technical Problem

The present disclosure has as its objective to be able to migrate a container without losing data while the container migrates.

### Solution to Problem

A container migration device of the present disclosure migrates a container that conducts data processing from a migration source apparatus to a migration destination apparatus.

The migration source apparatus is an apparatus in which a migration source container and a migration source proxy operate.

The migration destination apparatus is an apparatus in which a migration destination container and a migration destination proxy operate.

The container migration device includes:
a first transition unit to cause an operation mode of the migration source proxy, to transition from a transfer mode of: receiving data being transmitted from a request source container that requests the data processing; and transferring the received data to the migration source container being a request destination container, to a queuing mode of saving the data instead of transferring;
a second transition unit to cause, after the operation mode of the migration source proxy transitions to the queueing mode and the migration destination container is activated, the operation mode of the migration source proxy to transition to a queue sendout mode of sending out the saved data to the migration destination proxy; and
a transmission destination change unit to cause, after sendout of the saved data is completed, the request source container to change a data transmission destination from the migration source proxy to the migration destination proxy.

### Advantageous Effects of Invention

According to the present disclosure, it is possible to migrate a container without losing data while the container migrates.

### BRIEF DESCRIPTION OF DRAWINGS

FIG. 1 is a configuration diagram of an information processing system 100 in Embodiment 1.

FIG. 2 is a configuration diagram of a migration source apparatus 200 in Embodiment 1.

FIG. 3 is a configuration diagram of a migration management unit 230 in Embodiment 1.

FIG. 4 is a configuration diagram of a migration destination apparatus 300 in Embodiment 1.

FIG. 5 is a schematic diagram of a container migration method in Embodiment 1.

FIG. 6 is a schematic diagram of the container migration method in Embodiment 1.

FIG. 7 is a schematic diagram of the container migration method in Embodiment 1.

FIG. 8 is a schematic diagram of the container migration method in Embodiment 1.

FIG. 9 is a flowchart of the container migration method in Embodiment 1.

FIG. 10 illustrates an operation sequence of the information processing system 100 in Embodiment 1.

FIG. 11 illustrates an operation sequence of the information processing system 100 in Embodiment 1.

FIG. 12 illustrates an operation sequence of the information processing system 100 in Embodiment 1.

FIG. 13 is a hardware configuration diagram of the migration source apparatus 200 in Embodiment 1.

FIG. 14 is a hardware configuration diagram of the migration destination apparatus 300 in Embodiment 1.

### DESCRIPTION OF EMBODIMENTS

In the embodiment and drawings, the same elements or equivalent elements are denoted by the same reference numeral. A description of an element denoted by the same reference sign as that of a described element will appropriately be omitted or simplified. Arrows in the drawings mainly indicate data flows or processing flows.

### Embodiment 1

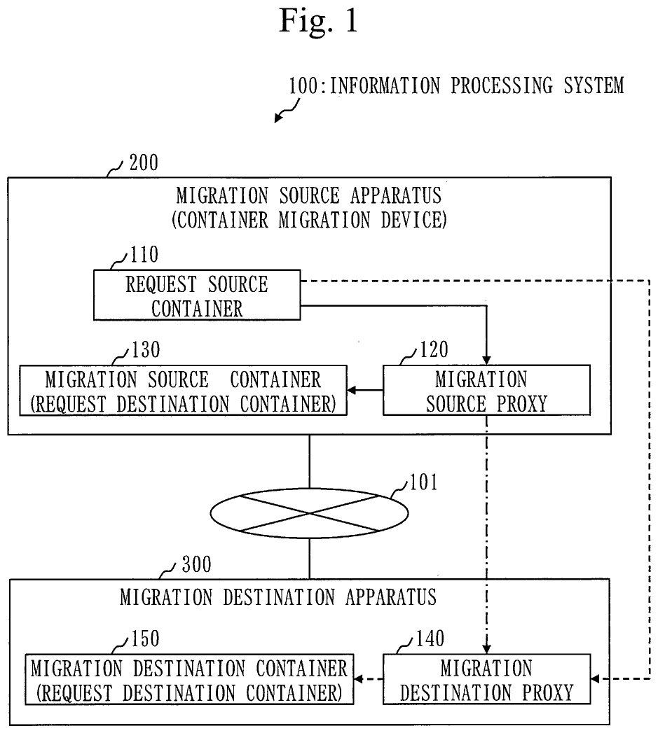

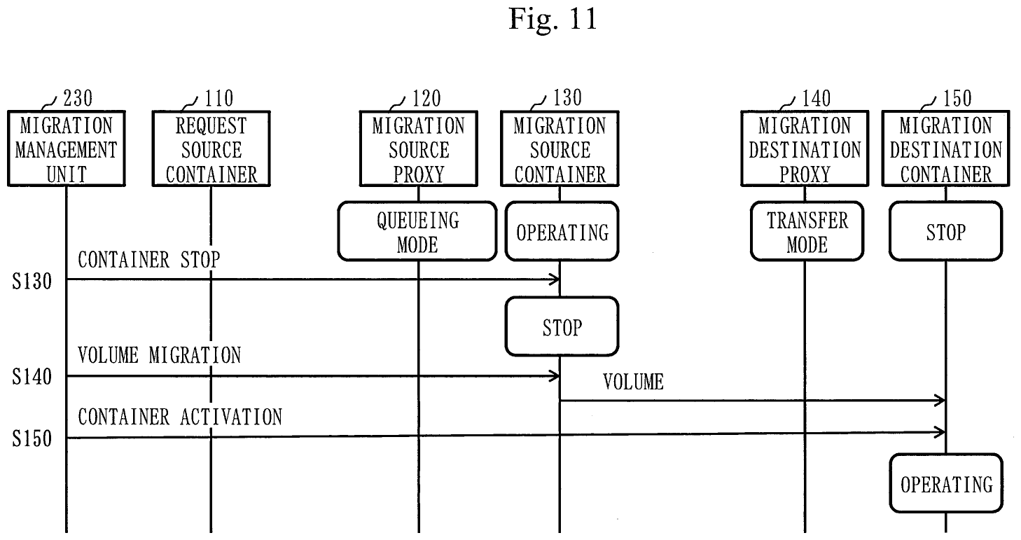

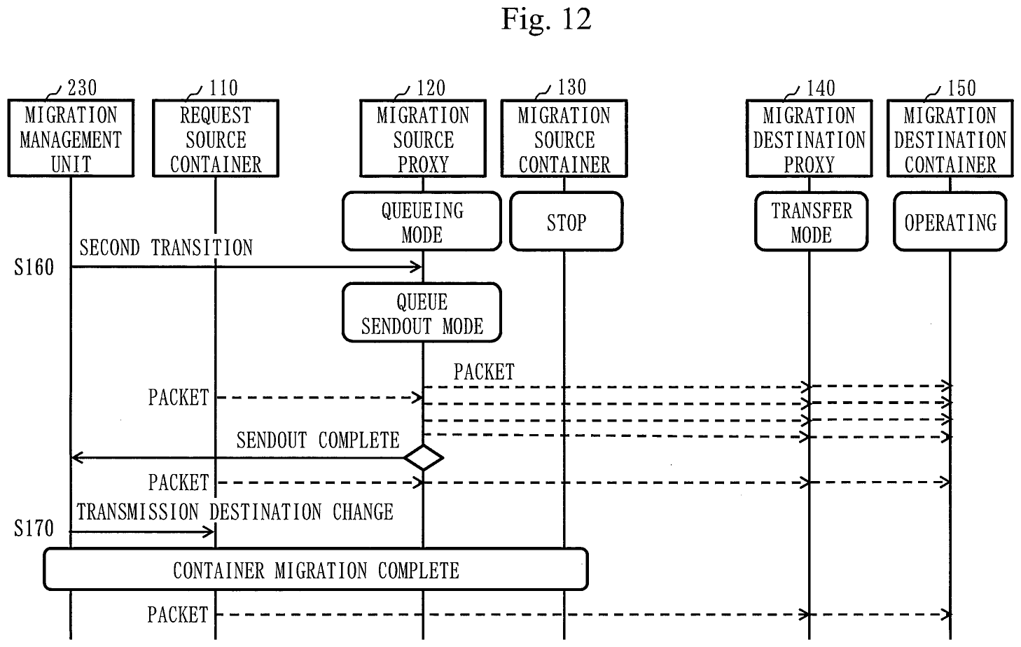

A mode of migrating a container that conducts data processing will be described with referring to FIGS. 1 to 14.

In Embodiment 1, a “container” signifies a software container, or a function block corresponding to a software container.

A “proxy” signifies a software proxy, or a function block corresponding to a software proxy.

### *** Description of Configuration ***

A configuration of an information processing system 100 will be described with referring to FIG. 1.

The information processing system 100 is provided with a migration source apparatus 200 and a migration destination apparatus 300.

The migration source apparatus 200 and the migration destination apparatus 300 communicate with each other via a network 101.

The migration source apparatus 200 and migration destination apparatus 300 have IP addresses that are different from each other. Note that IP stands for Internet Protocol.

The migration source apparatus 200 has a request source container 110, a migration source proxy 120, and a migration source container 130.

The request source container 110 is a container that transmits data and requests processing of the data.

The migration source proxy 120 is a proxy that receives the data from the request source container 110 before migration and transfers the received data to the migration source container 130.

The migration source container 130 is a before-migration request destination container.

The request destination container is a container that processes the data transmitted from the request source container 110.

The migration destination apparatus 300 has a migration destination proxy 140 and a migration destination container 150.

The migration destination proxy 140 is a proxy that receives the data from the request source container 110 after migration and transfers the received data to the migration destination container 150.

The migration destination container 150 is an after-migration request destination container.

The migration source apparatus 200 serves as a container migration device.

The container migration device migrates a container that conducts data processing, from the migration source apparatus 200 to the migration destination apparatus 300.

In FIG. 1, solid-line arrows indicate before-migration data flows, broken-line arrows indicate after-migration data flows, and alternate long-and-short-dashed-line arrows indicate during-migration data flows.

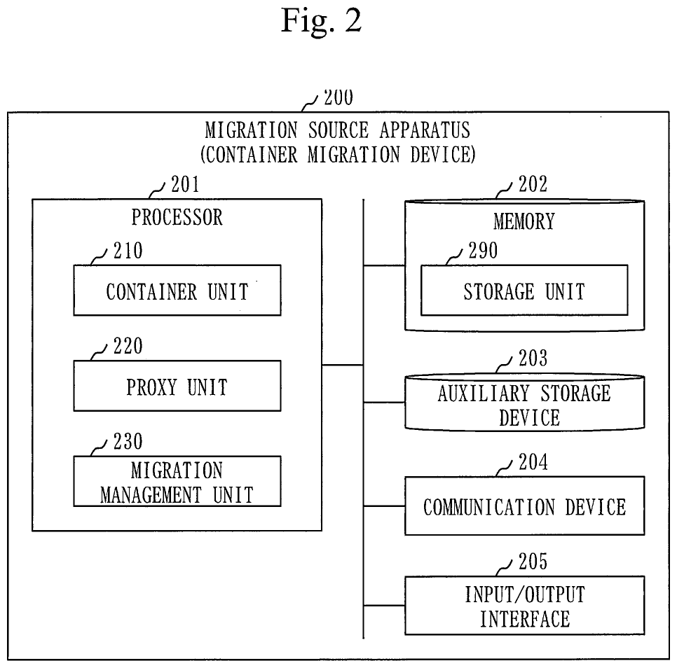

A configuration of the migration source apparatus 200 will be described with referring to FIG. 2.

The migration source apparatus 200 is a computer provided with hardware devices such as a processor 201, a memory 202, an auxiliary storage device 203, a communication device 204, and an input/output interface 205. These hardware devices are connected to each other via a signal line.

The processor 201 is an IC that performs computation processing, and controls the other hardware devices. For example, the processor 201 is a CPU.

Note that IC stands for Integrated Circuit.

Note that CPU stands for Central Processing Unit.

The memory 202 is a volatile or nonvolatile storage device. The memory 202 is called main storage device or main memory as well. For example, the memory 202 is a RAM. Data stored in the memory 202 is saved in the auxiliary storage device 203 as necessary.

Note that RAM stands for Random-Access Memory.

The auxiliary storage device 203 is a nonvolatile storage device. For example, the auxiliary storage device 203 is one, or a combination, of a ROM, an HDD, and a flash memory. The data stored in the auxiliary storage device 203 is loaded in the memory 202 as necessary.

Note that ROM stands for Read-Only Memory.

Note that HDD stands for Hard Disk Drive.

The communication device 204 is a receiver and transmitter. For example, the communication device 204 is a communication chip or an NIC. The migration source apparatus 200 performs communication by using the communication device 204.

Note that NIC stands for Network Interface Card.

The input/output interface 205 is a port to which an input device and an output device are connected. For example, the input/output interface 205 is a USB terminal, the input device is a keyboard and mouse, and the output device is a display. Input to and output from the migration source apparatus 200 are performed with using the input/output interface 205.

Note that USB stands for Universal Serial Bus.

The migration source apparatus 200 is provided with elements such as a container unit 210, a proxy unit 220, and a migration management unit 230. These elements are implemented by software.

The container unit 210 executes the request source container 110 and the migration source container 130.

The proxy unit 220 executes the migration source proxy 120.

The migration management unit 230 executes container migration.

The auxiliary storage device 203 stores a migration source program that causes the computer to function as the container unit 210, the proxy unit 220, and the migration management unit 230. The migration source program includes a container migration program that causes the computer to function as the migration management unit 230.

The migration source program is loaded to the memory 202 and run by the processor 201.

The auxiliary storage device 203 further stores an OS. At least part of the OS is loaded to the memory 202 and run by the processor 201.

The processor 201 runs the migration source program while running the OS.

Note that OS stands for Operating System.

Input/output data of the migration source program are stored in a storage unit 290.

The memory 202 functions as the storage unit 290. Note that a storage device such as the auxiliary storage device 203, a register in the processor 201, and a cache memory in the processor 201 may function as the storage unit 290 on behalf of the memory 202 or together with the memory 202.

The migration source apparatus 200 may be provided with a plurality of processors that substitute for the processor 201.

The migration source program can be computer readably recorded (stored) in a nonvolatile recording medium such as an optical disk and a flash memory.

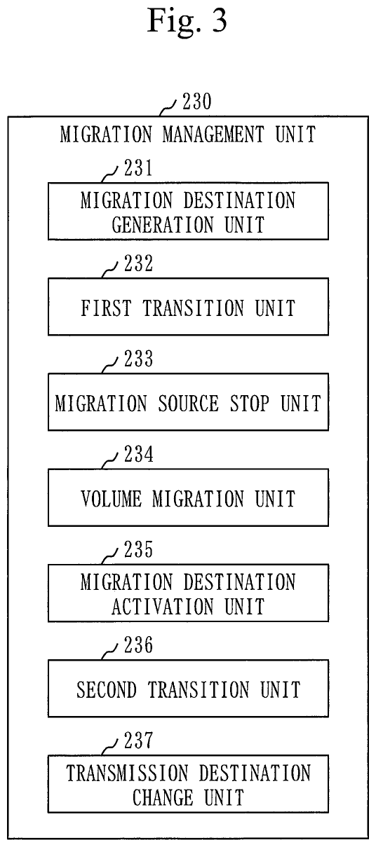

A configuration of the migration management unit 230 will be described with referring to FIG. 3.

The migration management unit 230 is provided with a migration destination generation unit 231, a first transition unit 232, a migration source stop unit 233, a volume migration unit 234, a migration destination activation unit 235, a second transition unit 236, and a transmission destination change unit 237.

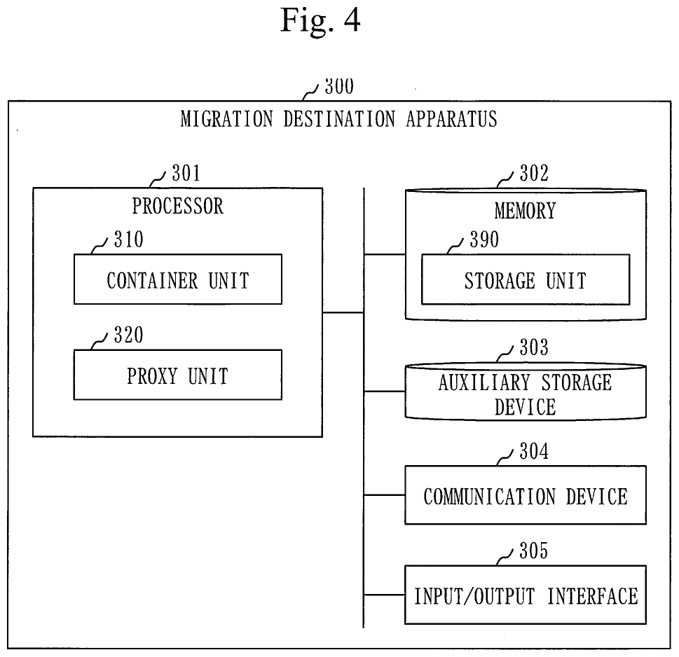

A configuration of the migration destination apparatus 300 will be described with referring to FIG. 4.

The migration destination apparatus 300 is a computer provided with hardware devices such as a processor 301, memory 302, an auxiliary storage device 303, a communication device 304, and an input/output interface 305. These hardware devices are connected to each other via a signal line.

The processor 301 is an IC that performs computation processing, and controls the other hardware devices. For example, the processor 301 is a CPU.

The memory 302 is a volatile or nonvolatile storage device. The memory 302 is called main storage device or main memory as well. For example, the memory 302 is a RAM. Data stored in the memory 302 is saved in the auxiliary storage device 303 as necessary.

The auxiliary storage device 303 is a nonvolatile storage device. For example, the auxiliary storage device 303 is one, or a combination, of a ROM, an HDD, and a flash memory. The data stored in the auxiliary storage device 303 is loaded in the memory 302 as necessary.

The communication device 304 is a receiver and transmitter. For example, the communication device 304 is a communication chip or an NIC. The migration destination apparatus 300 performs communication by using the communication device 304.

The input/output interface 305 is a port to which an input device and an output device are connected. For example, the input/output interface 305 is a USB terminal, the input device is a keyboard and mouse, and the output device is a display. Input to and output from the migration destination apparatus 300 are performed with using the input/output interface 305.

The migration destination apparatus 300 is provided with elements such as a container unit 310 and a proxy unit 320. These elements are implemented by software.

The container unit 310 generates and executes the migration destination container 150.

The proxy unit 320 generates and executes the migration destination proxy 140.

The auxiliary storage device 303 stores a migration destination program to cause the computer to function as the container unit 310 and the proxy unit 320. The migration destination program is loaded to the memory 302 and run by the processor 301.

The auxiliary storage device 303 further stores an OS. At least part of the OS is loaded to the memory 302 and run by the processor 301.

The processor 301 runs the migration destination program while running the OS.

Input/output data of the migration destination program are stored in a storage unit 390.

The memory 302 functions as the storage unit 390. Note that a storage device such as the auxiliary storage device 303, a register in the processor 301, and a cache memory in the processor 301 may function as the storage unit 390 on behalf of the memory 302 or together with the memory 302.

The migration destination apparatus 300 may be provided with a plurality of processors that substitute for the processor 301.

The migration destination program can be computer readably recorded (stored)

in a nonvolatile recording medium such as an optical disk and a flash memory.

### *** Description of Operations ***

A procedure of operations of the migration management unit 230 corresponds to a container migration method. The procedure of operations of the migration management unit 230 also corresponds to a procedure of processing conducted by the container migration program.

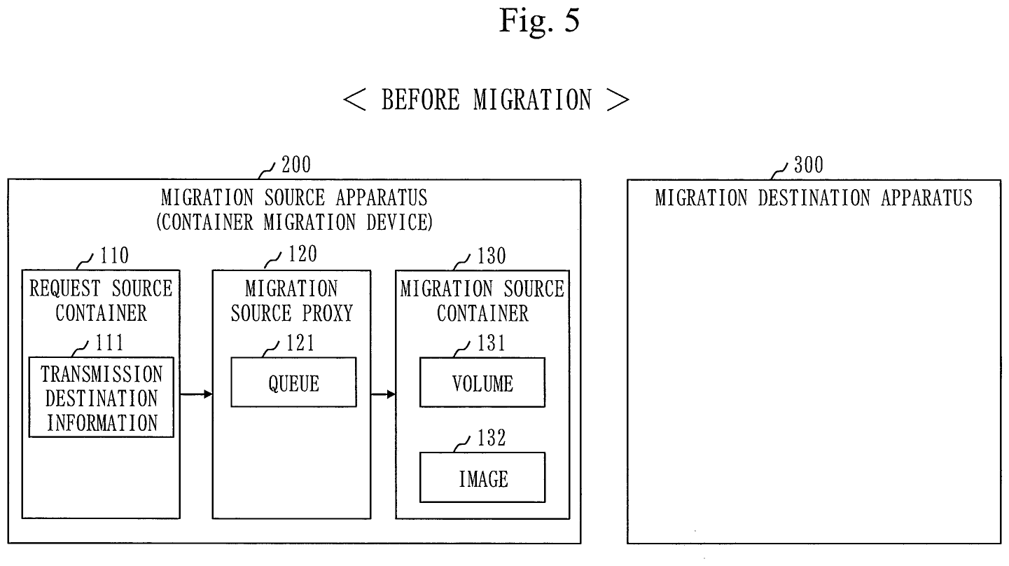

An outline of the container migration method will be described with referring to FIGS. 5 to 8.

FIG. 5 illustrates a state of the before-migration information processing system 100.

The request source container 110, the migration source proxy 120, and the migration source container 130 run in the migration source apparatus 200.

The request source container 110 has transmission destination information 111. The transmission destination information 111 indicates the migration source proxy 120 as a data transmission destination. The proxy is distinguished by, for example, a port number or a URL. Note that URL stands for Uniform Resource Locator.

The migration source proxy 120 has a queue 121.

The migration source container 130 has a volume 131 and an image 132. The volume 131 is prepared in a readable/writable storage area. Mainly data is read from and written in the volume 131 for the purpose of data processing. The image 132 is prepared in a read-only area. A library, a program, and so on for data processing are stored in the image 132.

The request source container 110 transmits a packet to the migration source proxy 120. The packet contains a data processing request and data to be processed.

The migration source proxy 120 receives the packet transmitted from the request source container 110 and enqueues the received packet to the queue 121. The migration source proxy 120 dequeues the packet in an order it was enqueued, and transfers the packet to the migration source container 130.

The migration source container 130 receives the packet transferred from the migration source proxy 120 and processes data in the received packet according to the request in the received packet.

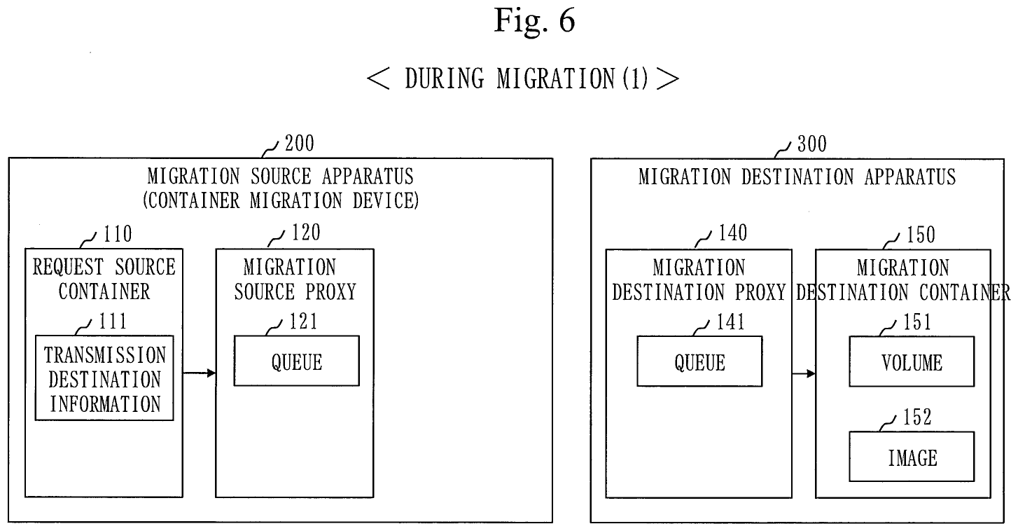

FIG. 6 illustrates a state of the information processing system 100 of during migration (1).

The migration source proxy 120 receives the packet transmitted from the request source container 110 and saves the received packet in the queue 121 (queuing).

The migration source proxy 120 does not transfer the packet to the migration source container 130.

The migration source container 130 is stopped.

In the migration destination apparatus 300, the migration destination proxy 140 and the migration destination container 150 are generated.

The migration destination proxy 140 has a queue 141. The queue 141 corresponds to the queue 121.

The migration destination container 150 has a volume 151 and an image 152. The volume 151 corresponds to the volume 131. The image 152 corresponds to the image 132.

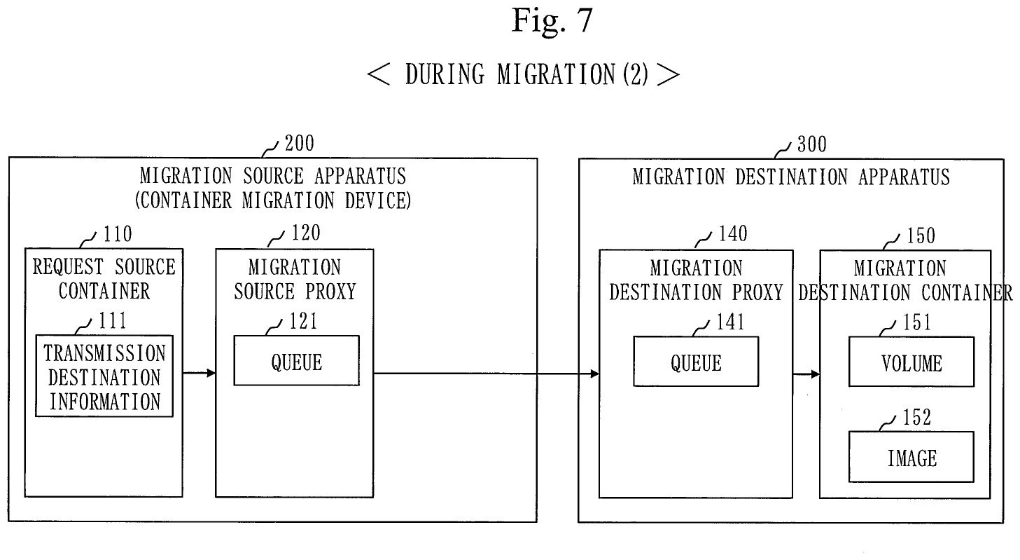

FIG. 7 illustrates a state of the information processing system 100 of during migration (2).

The migration destination container 150 is activated.

The migration source proxy 120 transmits the packet saved in the queue 121 to the migration destination proxy 140 in an order it was saved.

The migration destination proxy 140 receives the packet transmitted from the migration source proxy 120 and enqueues the received packet to the queue 141. The migration destination proxy 140 dequeues the packet in an order it was enqueued, and transfers the packet to the migration destination container 150.

The migration destination container 150 receives the packet transferred from the migration destination proxy 140 and processes data in the received packet according to the request in the received packet.

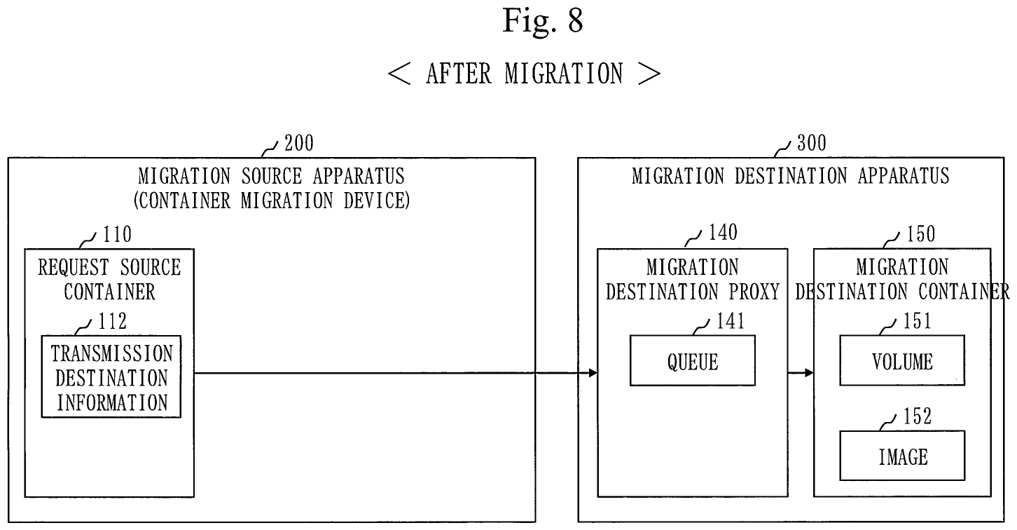

FIG. 8 illustrates a state of the after-migration information processing system 100.

Packet transmission from the migration source proxy 120 to the migration destination proxy 140 has been completed.

The request source container 110 updates the transmission destination information 111 with transmission destination information 112. The transmission destination information 112 indicates the migration destination proxy 140 as a data transmission destination.

The request source container 110 transmits a packet to the migration destination proxy 140.

The migration destination proxy 140 receives the packet transmitted from the request source container 110 and enqueues the received packet to the queue 141. The migration destination proxy 140 dequeues the packet in an order it was enqueued, and transfers the packet to the migration destination container 150.

The migration destination container 150 receives the packet transferred from the migration destination proxy 140 and processes data in the received packet according to the request in the received packet.

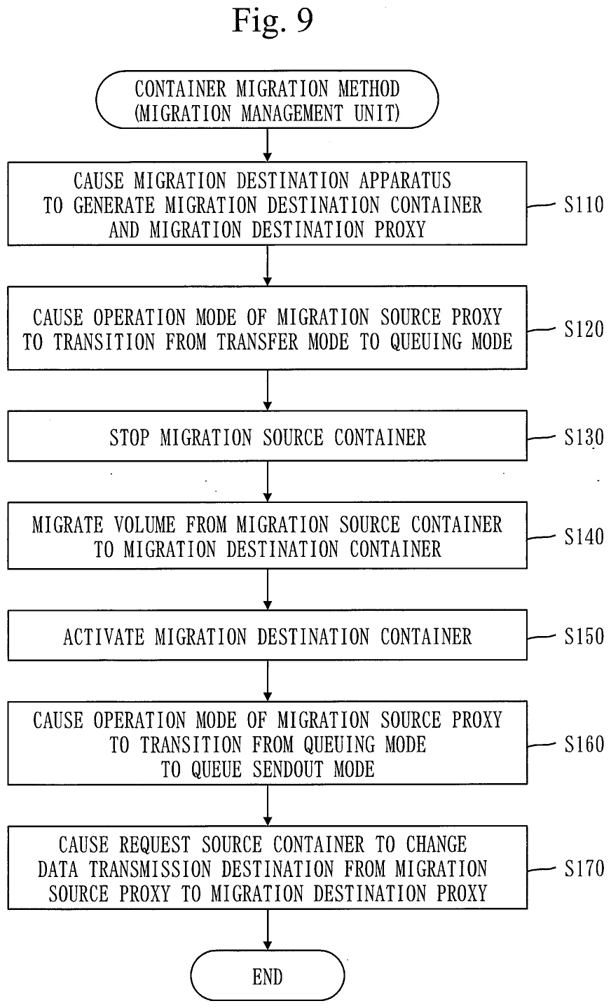

A procedure of the container migration method will be described with referring to FIGS. 9 to 12.

FIG. 9 illustrates a flowchart of the container migration method.

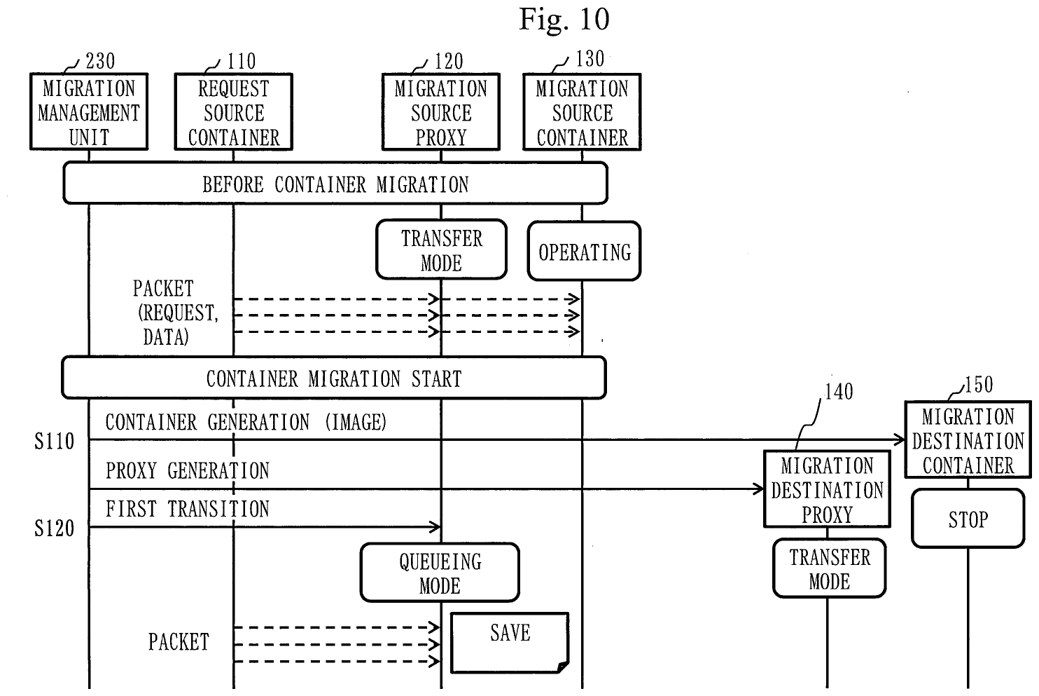

FIGS. 10 to 12 illustrate operation sequences of the information processing system 100.

Before start of container migration, an operation mode of the migration source proxy 120 is a transfer mode.

The transfer mode is an operation mode of receiving data being transmitted from the request source container 110 and transferring the received data to a request destination container. At this time, the request destination container is the migration source container 130. The data is contained in the packet.

The migration source container 130 is operating.

A procedure after start of container migration will be described below.

In step S110, the migration destination generation unit 231 causes the migration destination apparatus 300 to generate the migration destination container 150 and the migration destination proxy 140.

The migration destination container 150 is generated in the following manner.

The migration destination generation unit 231 transmits a container generation request including the image 132 of the migration source container 130 to the migration destination apparatus 300.

The container unit 310 receives the container generation request and generates the migration destination container 150 with using the image 132.

Note that the container unit 310 does not activate the migration destination container 150. That is, the migration destination container 150 has been stopped.

The migration destination proxy 140 is generated in the following manner.

The migration destination generation unit 231 transmits a proxy generation request to the migration destination apparatus 300.

The proxy unit 320 generates the migration destination proxy 140, activates the migration destination proxy 140, and sets the operation mode of the migration destination proxy 140 to the transfer mode.

In step S120, the first transition unit 232 causes the operation mode of the migration source proxy 120 to transition from the transfer mode to a queuing mode.

The queuing mode is an operation mode of saving data instead of transferring.

The operation mode of the migration source proxy 120 transitions in the following manner.

The first transition unit 232 instructs the proxy unit 220 to change the operation mode to the queuing mode.

The proxy unit 220 changes the operation mode of the migration source proxy 120 to the queuing mode according to the instruction.

During the queuing mode, the migration source proxy 120 saves the data transmitted from the request source container 110 to the queue 121.

In step S130, the migration source stop unit 233 stops the migration source container 130.

The migration source container 130 is stopped in the following manner.

The migration source stop unit 233 instructs the container unit 210 to stop the migration source container 130.

The container unit 210 stops the migration source container 130 according to the instruction.

In step S140, the volume migration unit 234 migrates the volume 131 from the migration source container 130 to the migration destination container 150.

The volume 131 is migrated in the following manner.

The volume migration unit 234 transfers the volume 131 of the migration source container 130 to the migration destination apparatus 300.

The container unit 310 receives the volume 131 and updates the volume 151 of the migration destination container 150 with using the volume 131.

In step S150, the migration destination activation unit 235 activates the migration destination container 150.

The migration destination container 150 is activated in the following manner.

The migration destination activation unit 235 transmits a container activation request to the migration destination apparatus 300.

The container unit 310 receives the container activation request and activates the migration destination container 150.

The migration destination container 150 starts operating.

In step S160, the second transition unit 236 causes the operation mode of the migration source proxy 120 to transition from the queuing mode to a queue sendout mode.

The queue sendout mode is an operation mode of sending out saved data to the migration destination proxy 140.

The operation mode of the migration source proxy 120 transitions in the following manner.

The second transition unit 236 instructs the proxy unit 220 to change the operation mode to the queue sendout mode.

The proxy unit 220 changes the operation mode of the migration source proxy 120 to the queue transfer mode according to the instruction.

During the queue sendout mode, the migration source proxy 120 transmits the data saved in the queue 121 to the migration destination proxy 140 in an order it was saved.

When data is received from the request source container 110, the migration source proxy 120 enqueues the received data to the queue 121. The enqueued data is transmitted to the migration destination proxy 140 in turn.

When all the data saved in the queue 121 are transmitted and the queue 121 becomes empty, the proxy unit 220 notifies the migration management unit 230 of sendout complete.

After that, when data is received from the request source container 110, the migration source proxy 120 enqueues the received data to the queue 121. The enqueued data is transmitted to the migration destination proxy 140 in turn.

In step S170, the transmission destination change unit 237 causes the request source container 110 to change a data transmission destination from the migration source proxy 120 to the migration destination proxy 140.

The data transmission destination is changed in the following manner.

The transmission destination change unit 237 instructs the container unit 210 to change the transmission destination to the migration destination proxy 140.

The container unit 210 changes the transmission destination indicated in the transmission destination information 111 from the migration source proxy 120 to the migration destination proxy 140 according to the instruction.

After step S170, container migration is completed.

After container migration is completed, the request source container 110 transmits data to the migration destination proxy 140.

The migration destination proxy 140 receives the data from the request source container 110 and transfers the received data to the migration destination container 150.

The migration destination container 150 receives the data from the migration destination proxy 140 and processes the received data.

### *** Description of Implementation Example ***

The migration management unit 230 may be provided to the migration destination apparatus 300 in place of to the migration source apparatus 200, or may be provided to another device.

The image 132 of the migration source container 130 need not be necessarily transferred at the time of generation of the migration destination container 150 (S110).

It suffices if the image 132 is transferred before activation of the migration destination container 150. For example, the image 132 may be transferred at the time of migration of the volume 131 (S140).

If the image 132 is transferred in advance, a time taken since stop of the migration source container 130 until activation of the migration destination container 150 can be shortened.

### *** Effect of Embodiment 1 ***

Embodiment 1 provides a technique that enables processing to be done with the container in an order of request without losing a request from a request source function block while the container is stopped.

Embodiment 1 introduces a communication proxy that enables queuing a packet (a request, data) between containers. With Embodiment 1, during migration of a container, the operation mode of the container is switched appropriately, so that the migration target container can process all packets in order without packet loss even during migration of the container.

### *** Supplement to Embodiment 1 ***

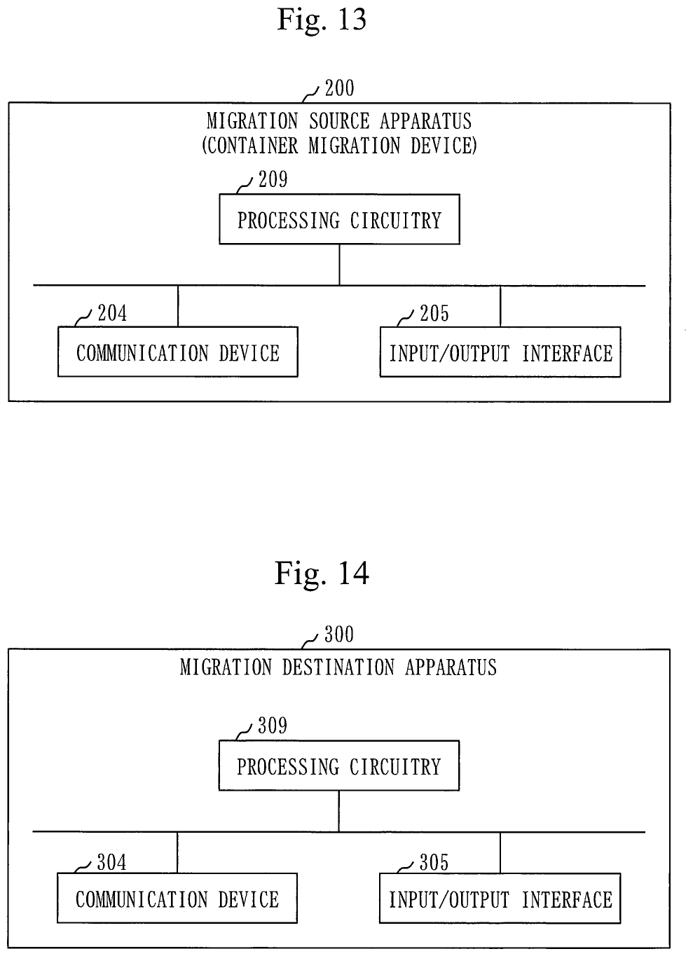

A hardware configuration of the migration source apparatus 200 will be described with referring to FIG. 13.

The migration source apparatus 200 is provided with processing circuitry 209.

The processing circuitry 209 is hardware that implements the container unit 210, the proxy unit 220, and the migration management unit 230.

The processing circuitry 209 may be dedicated hardware, or may be the processor 201 that runs the program stored in the memory 202.

When the processing circuitry 209 is dedicated hardware, the processing circuitry 209 is one, or a combination, of, for example, a single circuit, a composite circuit, a programmed processor, a parallel-programmed processor, an ASIC, and an FPGA.

Note that ASIC stands for Application Specific Integrated Circuit.

Note that FPGA stands for Field Programmable Gate Array.

The migration source apparatus 200 may be provided with a plurality of processing circuitries that substitute for the processing circuitry 209.

In the processing circuitry 209, some of the functions may be implemented by dedicated hardware, and the remaining functions may be implemented by software or firmware.

In this manner, the functions of the migration source apparatus 200 can be implemented by one, or a combination, of hardware, software, and firmware.

A hardware configuration of the migration destination apparatus 300 will be

described with referring to FIG. 14.

The migration destination apparatus 300 is provided with processing circuitry 309.

The processing circuitry 309 is hardware that implements the container unit 310 and the proxy unit 320.

The processing circuitry 309 may be dedicated hardware, or may be the processor 301 that runs the program stored in the memory 302.

When the processing circuitry 309 is dedicated hardware, the processing circuitry 309 is one, or a combination, of, for example, a single circuit, a composite circuit, a programmed processor, a parallel-programmed processor, an ASIC, and an FPGA.

The migration source apparatus 300 may be provided with a plurality of processing circuitries that substitute for the processing circuitry 309.

In the processing circuitry 309, some of the functions may be implemented by dedicated hardware, and the remaining functions may be implemented by software or firmware.

In this manner, the functions of the migration destination apparatus 300 can be implemented by one, or a combination, of hardware, software, and firmware.

Embodiment 1 is an exemplification of a preferred mode and is not intended to limit the technical scope of the present disclosure. Embodiment 1 may be practiced partly, or may be practiced in combination with another mode. The procedures explained with using the flowcharts and so on may be changed appropriately.

The word “unit” in each element of the migration source apparatus 200 and of the migration destination apparatus 300 may be replaced with “process”, “stage”, “circuit”, or “circuitry”.

### REFERENCE SIGNS LIST

100: information processing system; 101: network; 110: request source container; 111: transmission destination information; 112: transmission destination information; 120: migration source proxy; 121: queue; 130: migration source container; 131: volume; 132: image; 140: migration destination proxy; 141: queue; 150: migration destination container; 151: volume; 152: image; 200: migration source apparatus; 201: processor; 202: memory; 203: auxiliary storage device; 204: communication device; 205: input/output interface; 209: processing circuitry; 210: container unit; 220: proxy unit; 230: migration management unit; 231: migration destination generation unit; 232: first transition unit; 233: migration source stop unit; 234: volume migration unit; 235: migration destination activation unit; 236: second transition unit; 237: transmission destination change unit; 290: storage unit; 300: migration destination apparatus; 301: processor; 302: memory; 303: auxiliary storage device; 304: communication device; 305: input/output interface; 309: processing circuitry; 310: container unit; 320: proxy unit; 390: storage unit.

1. A container migration device which migrates a container that conducts data processing from a migration source apparatus to a migration destination apparatus,
the migration source apparatus being an apparatus in which a migration source container and a migration source proxy operate,
the migration destination apparatus being an apparatus in which a migration destination container and a migration destination proxy operate,
the container migration device comprising:
processing circuitry
to cause an operation mode of the migration source proxy, to transition from a transfer mode of: receiving data being transmitted from a request source container that requests the data processing; and transferring the received data to the migration source container being a request destination container, to a queuing mode of saving the data instead of transferring,
to cause, after the operation mode of the migration source proxy transitions to the queueing mode and the migration destination container is activated, the operation mode of the migration source proxy to transition to a queue sendout mode of sending out the saved data to the migration destination proxy, and
to cause, after sendout of the saved data is completed, the request source container to change a data transmission destination from the migration source proxy to the migration destination proxy.

2. The container migration device according to claim 1,
wherein the processing circuitry
causes the migration destination apparatus to generate the migration destination container and the migration destination proxy,
stops the migration source container after the operation mode of the migration source proxy transitions to the queuing mode,
migrates a volume from the migration source container to the migration destination container after the migration source container is stopped, and
activates activate the migration destination container after the volume is migrated.

3. A container migration method of migrating a container that conducts data processing from a migration source apparatus to a migration destination apparatus,
the migration source apparatus being an apparatus in which a migration source container and a migration source proxy operate,
the migration destination apparatus being an apparatus in which a migration destination container and a migration destination proxy operate,
the container migration method comprising:
causing an operation mode of the migration source proxy, to transition from a transfer mode of: receiving data being transmitted from a request source container that requests the data processing; and transferring the received data to the migration source container being a request destination container, to a queuing mode of saving the data instead of transferring;
after the operation mode of the migration source proxy transitions to the queueing mode and the migration destination container is activated, causing the operation mode of the migration source proxy to transition to a queue sendout mode of sending out the saved data to the migration destination proxy; and
causing, after sendout of the saved data is completed, the request source container to change a data transmission destination from the migration source proxy to the migration destination proxy.

4. A container migration method of migrating a container that conducts data processing from a migration source apparatus to a migration destination apparatus,
the migration source apparatus being an apparatus in which a migration source container and a migration source proxy operate,
the migration destination apparatus being an apparatus in which a migration destination container and a migration destination proxy operate,
the container migration method comprising:
receiving data being transmitted from a request source container that requests the data processing; and transferring the received data to the migration source container being a request destination container;
after receiving an instruction to transition from a transfer mode to a queueing mode, receiving the data being transmitted from the request source container; and saving the received data instead of transferring; and
after receiving an instruction to transition from the queuing mode to a queue sendout mode, sending out the saved data to the migration destination proxy.

5. A non-transitory computer readable medium recorded with a container migration program to migrate a container that conducts data processing from a migration source apparatus to a migration destination apparatus,
the migration source apparatus being an apparatus in which a migration source container and a migration source proxy operate,
the migration destination apparatus being an apparatus in which a migration destination container and a migration destination proxy operate,
the container migration program serving to cause a computer to execute:
a first transition process of causing an operation mode of the migration source proxy, to transition from a transfer mode of; receiving data being transmitted from a request source container that requests the data processing; and transferring the received data to the migration source container being a request destination container, to a queuing mode of saving the data instead of transferring;
a second transition process of causing, after the operation mode of the migration source proxy transitions to the queueing mode and the migration destination container is activated, the operation mode of the migration source proxy to transition to a queue sendout mode of sending out the saved data to the migration destination proxy; and
a transmission destination change process of causing, after sendout of the saved data is completed, the request source container to change a data transmission destination from the migration source proxy to the migration destination proxy.
